(19) United States
(12) Patent Application Publication
(10) Pub. No.: US 2006/0141382 A1
(43) Pub. Date: Jun. 29, 2006

(54) Resist composition and method of forming resist pattern using same

(76) Inventors: Masaru Takeshita, Kawasaki-shi (JP); Miwa Miyairi, Kawasaki-shi (JP); Hideo Hada, Kawasaki-shi (JP); Takeshi Iwai, Kawasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/531,883

(22) PCT Filed: Dec. 18, 2003
(86) PCT No.: PCT/JP03/16267

§ 371 Date: Apr. 19, 2005

(30) Foreign Application Priority Data
Dec. 25, 2002 (JP) P 2002-373936
Oct. 15, 2003 (JP) P 2003-355418

(51) Int. Cl. G03C 1/76

(52) U.S. Cl. 430/270.1

(57) ABSTRACT

There are provided a resist composition that produces a resist pattern of good shape, and a method of forming a resist pattern that uses such a resist composition. The resist composition comprises a resin component (A) that undergoes a change in alkali solubility under the action of acid, an acid generator component (B) that generates acid on exposure, and an organic solvent (C), wherein the component (B) comprises a compound represented by a general formula (I) shown below [wherein, R¹ to R³ each represent, independently, a methyl group or an ethyl group; and X⁻ represents an anion].

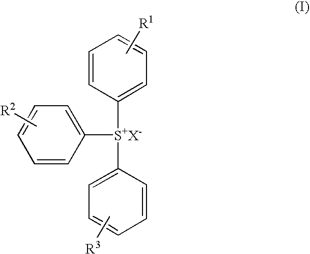

### TECHNICAL FIELD

The present invention relates to a resist composition and a method of forming a resist pattern using such a resist composition.

### BACKGROUND ART

In recent years, in the production of semiconductor elements and liquid crystal display elements, advances in lithography techniques have lead to rapid progress in the field of miniaturization. Typically, these miniaturization techniques involve shortening of the wavelength of the exposure light source.

One example of a known resist that satisfies the high resolution requirements needed to reproduce a pattern with very minute dimensions is a chemically amplified resist composition in which a base resin that undergoes a change in alkali solubility under the action of acid, and an acid generator that generates acid on exposure are dissolved in an organic solvent (for example, see the patent references 1 to 3).

(Patent Reference 1)

Japanese Unexamined Patent Application, First Publication No. 2002-201232

(Patent Reference 2)

Japanese Unexamined Patent Application, First Publication No. 2002-278069

(Patent Reference 3)

Japanese Unexamined Patent Application, First Publication No. 2002-278071

As disclosed in the types of chemically amplified resist compositions described above, typical known acid generators include unsubstituted triphenylsulfonium salts and tri(tert-butylphenyl)sulfonium salts. These types of onium salts have long been known, and are low cost and readily available.

However, in those cases where a resist layer is formed using this type of onium salt, and a resist pattern is then formed by exposure with, for example, an ArF excimer laser (wavelength=193 nm), a problem arises in that the resist pattern shape is not ideal.

In other words, in the case of the former onium salt, if a line and space (L&S) pattern is formed, then phenomena such that the top section of the pattern is smaller, producing a tapered shape when viewed in cross section, that film thinning is caused, or that white bands on the line side walls are caused. White bands are white lines that appear on the line side walls when the aforementioned tapered shape is viewed from a position directly above the resist pattern.

In contrast, in the case of the latter onium salt, the line cross sectional shape tends to adopt a T-top shape.

### DISCLOSURE OF INVENTION

Accordingly, an object of the present invention is to provide a resist composition that produces a resist pattern of excellent shape, as well as a method of forming a resist pattern that utilizes such a resist composition.

As a result of intensive investigations aimed at resolving the above problems, the inventors of the present invention discovered that by using a resist composition comprising a specific acid generator, a resist pattern of good shape could be obtained, and were hence able to complete the present invention.

In other words, a first aspect of the present invention for resolving the above problems provides a resist composition comprising a resin component (A) that undergoes a change in alkali solubility under the action of acid, an acid generator component (B) that generates acid on exposure, and an organic solvent (C), wherein the component (B) is a compound represented by a general formula (I) shown below: 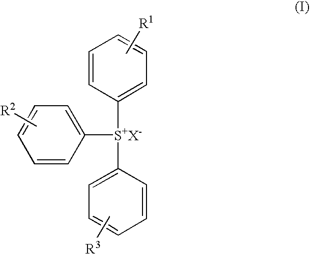
[wherein, R¹ to R³ each represent, independently, a methyl group or an ethyl group; and X⁻ represents an anion].

A second aspect of the present invention for resolving the above problems provides a method of forming a resist pattern comprising the steps of applying the resist composition described above to a substrate, conducting a prebake, performing selective exposure, conducting subsequent PEB (post exposure baking), and then performing alkali developing to form a resist pattern.

By incorporating the specific compound represented by the general formula (I) as an acid generator, a resist composition of the present invention enables the formation of a resist pattern of superior shape.

Furthermore, a resist composition of the present invention displays minimal particle risk, and offers excellent resist storage stability. In addition, the depth of focus characteristics are also excellent.

### BEST MODE FOR CARRYING OUT THE INVENTION

As follows is a more detailed description of embodiments of the present invention, using a series of examples.

In this description, the term “(meth)acrylic acid” refers to either one of, or both methacrylic acid and acrylic acid. The term “structural unit” refers to a monomer unit that contributes to the formation of a polymer. Furthermore, a “structural unit derived from a (meth)acrylate ester” may also be referred to as a “(meth)acrylate structural unit”. Furthermore, the term “lactone unit” refers to a group in which one hydrogen atom has been removed from a monocyclic or polycyclic lactone.

<<Positive Resist Composition>>

<Component (B)>

The present invention is characterized by a component (13) that is a compound represented by the general formula (I) shown above (hereafter referred to as a compound (I)). In other words, a compound represented by the general formula (I) is used as the component (B).

In the general formula (I), each of the groups R¹ to R³ may be either-a methyl group or an ethyl group, although R¹ to R³ preferably represent the same group, and the case in which R¹ to R³ are all methyl groups is preferred. In such a case, the shape of the produced resist pattern is less prone to forming a tapered shape or a T-top shape, and displays superior verticalness. Furthermore, the occurrence of white bands on the side walls of the resist pattern also improves. In addition, the particle risk (the danger of impurities) is low, the storage stability improves, and the focus margin of the DOF is also favorably large.

Furthermore, each of the groups R¹ to R³ may be bonded to any position of the respective phenyl groups, although in terms of industrial availability, bonding at the para position is preferred.

There are no particular restrictions on the X⁻ anion, which can be appropriately selected from the multitude of ions that have been proposed for acid generators for use in chemically amplified resist compositions, although in the field of semiconductor element production, avoiding the use of metal ions improves the reliability of the semiconductor element, and consequently, anions that contain no metal ions such as arsenic or tin are preferred.

Examples of preferred anions that can be used as X⁻ include substituted or unsubstituted aliphatic or aromatic alkylsulfonate ions.

From the viewpoint of the degree of diffusion of the generated acid through the resist film, alkylsulfonate ions of 1 to 10 carbon atoms, and particularly from 1 to 8 carbon atoms are preferred. Furthermore, the alkyl group may be a straight chain, a branched chain, or cyclic, although from the viewpoint of the aforementioned degree of diffusion, straight chain groups are preferred.

Amongst these types of alkylsulfonate ions, fluoroalkylsulfonate ions in which either a portion of, or all of, the hydrogen atoms of the aliphatic or aromatic alkyl group have been fluorinated are particularly preferred.

The degree of fluorination of the alkyl group hydrogen atoms is preferably within a range from 50 to 100%, and anions in which all of the hydrogen atoms have been substituted with fluorine atoms offer stronger acidity, and are consequently particularly desirable.

Specific examples include compounds represented by a general formula (II) shown below: 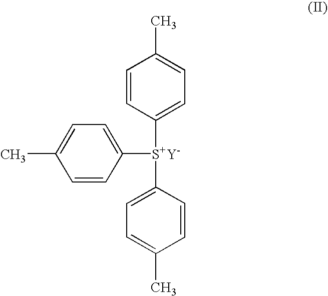
[wherein, Y⁻ represents a trifluoromethanesulfonate ion, a nonafluorobutanesulfonate ion, or a perfluorooctylsulfonate ion].

The compounds (I) described above [including compounds of the formula (II)] can be used singularly, or in combinations of two or more different compounds.

The quantity added of the component (B) should be determined with due consideration given to the balance with other components such as the component (A) described below, although a typical quantity is within a range from 0.5 to 20 parts by weight, and preferably from 1 to 10 parts by weight, per 100 parts by weight of the component (A). By using a quantity of at least 0.5 parts by weight, satisfactory pattern formation can be ensured. In contrast, ensuring that the quantity is no more than 20 parts by weight allows easier formation of a uniform solution, and enables the formation of a resist pattern of superior shape. Furthermore, there is also a tendency for the particle risk to decrease, and the storage stability to improve.

The compound (I) can be produced by those methods typically used for producing sulfonium salts.

Examples of typical methods include a method in which a sulfide derivative (such as bis(p-methylphenyl)sulfide) is reacted with a Grignard reagent such as p-methylphenylmagnesium bromide and a salt that corresponds with the anion (such as potassium nonafluorobutanesulfonate) in an organic solvent.

<Component (A)>

The component (A) can utilize either one or more of the alkali soluble resins, or resins that can be converted to an alkali soluble state, that are typically used as the base resin for chemically amplified resists. The former describes a so-called negative type resist composition, and the latter describes a positive type resist composition. A resist composition of the present invention is preferably a positive type composition.

In the case of a negative type composition, a cross linking agent is added with the component (B). Then, during resist pattern formation, when acid is generated from the component (B) by exposure, this acid acts on the cross linking agent, causing cross linking between the component (A) and the component (B), and making the composition alkali insoluble. The cross linking agent typically uses a melamine compound comprising a methylol group or an alkoxymethyl group, or an amino based cross linking agent such as urea or glycoluril.

In the case of a positive type composition, the component (A) is an alkali insoluble compound with an acid dissociable, dissolution inhibiting group, and when acid is generated from the component (B) by exposure, this acid causes the acid dissociable, dissolution inhibiting group to dissociate, making the component (A) alkali soluble.

The component (A) preferably comprises a resin containing a (meth)acrylate structural unit. Incorporating at least 20 mol %, and preferably 50 mol % or greater of (meth)acrylate structural units within the component (A) increases the effect of the component (B), which is desirable.

Specifically, a resin containing a structural unit (a1) described below is preferred. (a1): a (meth)acrylate structural unit containing an acid dissociable, dissolution inhibiting group.

This resin may also contain any of the optional structural units (a2) to (a4) described below:

(a2): a (meth)acrylate structural unit containing a lactone unit

(a3): a (meth)acrylate structural unit containing a hydroxyl group

(a4): other structural units different from (a1) to (a3).

[Structural Unit (a1)]

The acid dissociable, dissolution inhibiting group of the structural unit (a1) displays an alkali dissolution inhibiting effect that causes the entire component (A) to be alkali insoluble prior to exposure, but dissociates under the action of acid generated from the acid generator following exposure, causing the entire component (A) to become alkali soluble.

Examples of the acid dissociable, dissolution inhibiting group can be appropriately selected from the multitude of groups that have been proposed for ArF excimer laser resist composition resins. Typically, groups which form a cyclic or chain-type tertiary alkyl ester at the carboxyl group of (meth)acrylic acid are widely known

From the viewpoints of achieving superior transparency and dry etching resistance, the structural unit (a1) preferably comprises a structural unit that contains an acid dissociable, dissolution inhibiting group containing an aliphatic polycyclic group. This polycyclic group can be appropriately selected from the multitude of groups proposed for use with ArF resists. Examples include groups in which either one or two hydrogen atoms have been removed from a bicycloalkane, a tricycloalkane or a tetracycloalkane or the like.

Specific examples include groups in which either one or two hydrogen atoms have been removed from a polycycloalkane such as adamantane, norbornane, isobornane, tricyclodecane or tetracyclododecane.

Of these groups, adamantyl groups in which one hydrogen atom has been removed from adamantane, norbornyl groups in which one hydrogen atom has been removed from norbornane, and tetracyclododecanyl groups in which one hydrogen atom has been removed from tetracyclododecane are preferred in terms of industrial availability.

Specifically, the structural unit (a1) is preferably at least one unit selected from a group consisting of the general formulas (III), (IV) and (V) shown below. 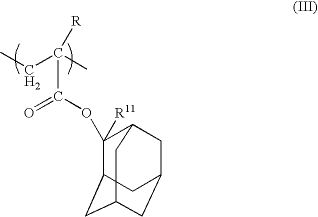
(wherein, R represents a hydrogen atom or a methyl group, and R¹¹ represents a lower alkyl group) 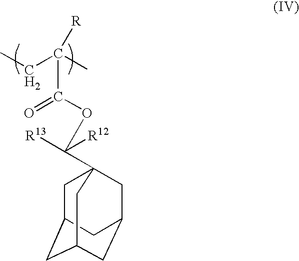
(wherein, R represents a hydrogen atom or a methyl group, and R¹² and R¹³ each represent, independently, a lower alkyl group) 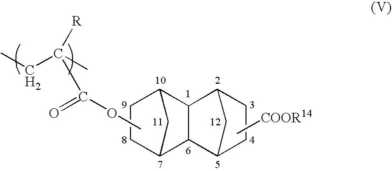
(wherein, R represents a hydrogen atom or a methyl group, and R¹⁴ represents a tertiary alkyl group)

The structural unit represented by the general formula (III) is a (meth)acrylate structural unit with a hydrocarbon group bonded through an ester linkage, and by bonding a straight chain or a branched chain alkyl group to the carbon atom of the adamantyl group that is adjacent to the oxygen atom (—O—) of the ester function, a tertiary alkyl group is formed within the ring skeleton of the adamantyl group.

Within the above formula, the group R¹¹ is preferably a straight chain or branched alkyl group of 1 to 5 carbon atoms, and specific examples include a methyl group, ethyl group, propyl group, isopropyl group, n-butyl group, isobutyl group, tert-butyl group, pentyl group, isopentyl group and neopentyl group. Of these, an alkyl group of at least 2 carbon atoms, and preferably from 2 to 5 carbon atoms is preferred, and in such cases, the acid dissociability tends to increase compared with the case in which R¹¹ is a methyl group. From an industrial viewpoint, a methyl group or an ethyl group is preferred.

The (meth)acrylate structural unit represented by the aforementioned general formula (IV), like the general formula (III), is a (meth)acrylate structural unit with a bonded hydrocarbon group, although in this case, the carbon atom adjacent to the oxygen atom (—O—) of the ester function of the (meth)acrylate structural unit is a tertiary alkyl group, and a ring skeleton such as an adamantyl group exists within this alkyl group.

The groups R¹² and R¹³ each preferably represent, independently, a lower alkyl group of 1 to 5 carbon atoms. These types of groups tend to display a higher acid dissociability than a 2-methyl-2-adamantyl group.

Specifically, the groups R¹² and R¹³ each represent, independently, the same types of straight chain or branched lower alkyl groups described above for R¹¹. Of these groups, the case in which R¹² and R¹³ are both methyl groups is preferred in terms of industrial availability.

The structural unit represented by the general formula (V) is a unit in which a carbon atom adjacent to the oxygen atom (—O—) of a different terminal ester function from the ester of the (meth)acrylate structural unit is a tertiary carbon atom of a tertiary alkyl group, and the (meth)acrylate structural unit and the other ester are linked via a ring skeleton such as a tetracyclododecanyl group.

In the formula, R¹⁴ represents a tertiary alkyl group such as a tert-butyl group or a tert-amyl group, although a tert-butyl group is preferred in terms of industrial availability.

Furthermore, the group —COOR¹⁴ may be bonded to either position 3 or 4 of the tetracyclododecanyl group shown in the formula, although a mixture of both stereoisomers results, and so the bonding position cannot be further specified. Furthermore, the carboxyl group residue of the (meth)acrylate structural unit may be bonded to either position 9 or 10 of the tetracyclododecanyl group, although similarly, a mixture of both stereoisomers results, and so the bonding position cannot be further specified.

Of these, the structural unit (a1) preferably utilizes at least one of the structural units represented by the general formulas (III) and (IV). Structural units represented by the general formula (III) are particularly preferred, and in this case, the R¹¹ group is preferably a methyl group or an ethyl group. Furthermore, using structural units of both the general formula (III) and the general formula (IV) is also preferred, and the case in which R¹¹ is a methyl group, and R¹² and R¹³ are also both methyl groups provides excellent resolution, and is consequently preferred.

The structural unit (a1) typically accounts for 20 to 60 mol %, and preferably from 30 to 50 mol % of the total of all the structural units within the component (A). By ensuring the quantity exceeds the lower limit of the above range, the solubility of the polymer becomes more readily altered in the presence of acid, providing superior resolution, when the component (A) is used as a positive resist composition. If the quantity exceeds the upper limit of the above range, there is a danger of a deterioration in the adhesion between the resist pattern and the substrate as a result of factors such as an inadequate manifestation of the effects of the other structural units.

[Structural Unit (a2)]

A lactone unit, namely a group in which one hydrogen atom has been removed from a monocyclic or a polycyclic lactone, is a polar group, and consequently when the component (A) is used as a positive resist composition, the structural unit (a2) is effective in increasing the adhesion between the resist film and the substrate, and improving the affinity with the developing liquid.

There are no particular restrictions on the structural unit (a2), provided it contains this type of lactone unit.

Examples of the lactone unit include groups in which one hydrogen atom has been removed from the lactones shown in the structural formulas below.

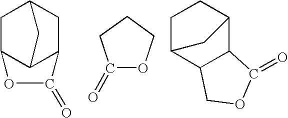

Furthermore in the structural unit (a2), the lactone unit is preferably at least one unit selected from a group consisting of units of the general formula (VI) and the general formula (VII) shown below.

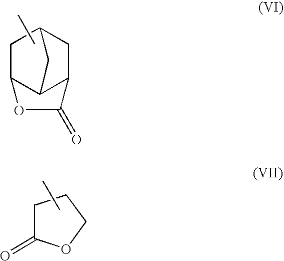

Specific examples of the structural unit (a2) include the (meth)acrylate structural units represented by the structural formulas shown below. 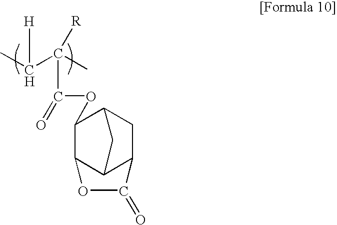
(wherein, R represents a hydrogen atom or a methyl group) 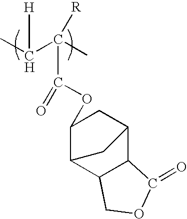
(wherein, R represents a hydrogen atom or a methyl group) 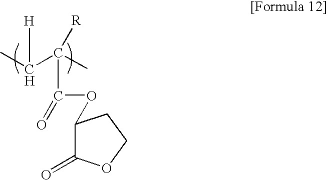
(wherein, R represents a hydrogen atom or a methyl group) 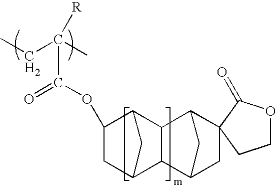
(wherein, R represents a hydrogen atom or a methyl group, and m is either 0 or 1)

Of the above structural units, γ-butyrolactone esters of (meth)acrylic acid with an ester linkage at the α-carbon atom (formula 12), or norbornane lactone esters (formula 10), are particularly preferred in terms of industrial availability.

The structural unit (a2) preferably accounts for 20 to 60 mol %, and even more preferably from 30 to 50 mol % of the total of all the structural units within the component (A). If the quantity is less than the lower limit of the above range, the resolution deteriorates, whereas if the quantity exceeds the upper limit, there is a danger that the component will become difficult to dissolve in the resist solvent.

[Structural Unit (a3)]

Because the structural unit (a3) described above contains a hydroxyl group, use of the structural unit (a3) results in an increased affinity with the developing liquid for the entire component (A), and an improvement in the alkali solubility of the exposed sections of the resist. Accordingly, the structural unit (a3) contributes to an improvement in the resolution.

The structural unit (a3) can be appropriately selected from the multitude of ArF excimer laser resist composition resins that have been proposed, and structural units comprising polycyclic groups that contain hydroxyl groups are preferred.

The polycyclic group can be appropriately selected from the various polycyclic groups listed in the above description for the structural unit (a1).

Specifically, preferred examples of the structural unit (a3) include hydroxyl group containing adamantyl groups (in which the number of hydroxyl groups is preferably from 1 to 3, and most preferably 1), and carboxyl group containing tetracyclododecanyl groups (in which the number of carboxyl groups is from 1 to 3, and most preferably 1).

Hydroxyl group containing adamantyl groups are particularly preferred. Specifically, if the structural unit (a3) is a structural unit represented by a general formula (VIII) shown below, then the dry etching resistance improves, as does the verticalness of the pattern cross section, both of which are desirable. 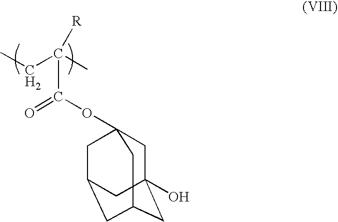
(wherein, R represents a hydrogen atom or a methyl group)

The structural unit (a3) typically accounts for 5 to 50 mol %, and preferably from 10 to 40 mol % of the total of all the structural units within the component (A). By ensuring the quantity exceeds the lower limit of the above range, the improvement in the LER (line edge roughness) is favorable, whereas if the quantity exceeds the upper limit of the above range, there is a danger of a deterioration in the resist pattern shape as a result of factors such as an unsatisfactory balance with the other structural units.

[Structural Unit (a4)]

The resin may also contain an optional structural unit (a4) that is different from the aforementioned structural units (a1) to (a3).

There are no particular restrictions on the structural unit (a4), provided it cannot be classified as one of the above structural units (a1) to (a3). In other words, any structural unit that does not contain an acid dissociable, dissolution inhibiting group, a lactone and a hydroxyl group can be included. For example, (meth)acrylate structural units that contain a polycyclic group are preferred. If this type of structural unit is used, then when the component (A) is used as a positive resist composition, the resolution for isolated patterns through to semi dense patterns (line and space patterns in which for a line width of 1, the space width is within a range from 1.2 to 2) is excellent, and consequently preferred.

Examples of the polycyclic group include the same groups listed in the above description for the structural unit (a1), and any of the multitude of materials conventionally used for ArF positive resist materials or KrF positive resist materials can be used.

From the viewpoint of industrial availability, at least one of a tricyclodecanyl group, an adamantyl group or a tetracyclododecanyl group is preferred.

Specific examples of the structural unit (a4) include the structures represented by the formulas (IX) to (XI) shown below. 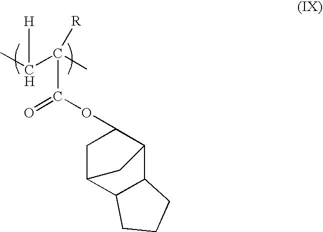
(wherein, R represents a hydrogen atom or a methyl group) 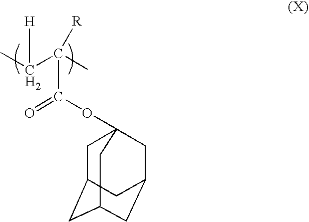
(wherein, R represents a hydrogen atom or a methyl group) 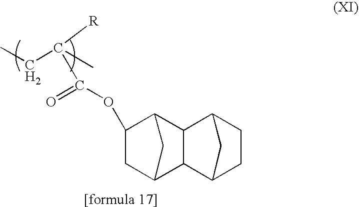
(wherein, R represents a hydrogen atom or a methyl group)

Compositions in which the structural unit (a4) accounts for 1 to 30 mol %, and preferably from 5 to 20 mol % of the total of all the structural units within the component (A) display excellent resolution for isolated patterns through to semi dense patterns, and are consequently preferred.

Amongst the structural units of the component (A), the structural units (a2) to (a4) can be appropriately selected and combined with the structural unit (a1) in accordance with the target application, although compositions comprising all of the structural units (a1) to (a4) are preferred in terms of etching resistance, resolution, and adhesion between the resist film and the substrate. Depending on the application, other structural units may also be used in addition to the structural units from (a1) to (a4).

For example, for binary polymers comprising the structural unit (a1) and the structural unit (a2), polymers in which the structural unit (a1) accounts for 30 to 70 mol %, and preferably from 40 to 60 mol %, and the structural unit (a2) accounts for 30 to 70 mol %, and preferably from 40 to 60 mol % of all the structural units, offer better control during the synthesis of the resin, and are consequently preferred.

Furthermore, for tertiary systems that further comprise the structural unit (a3), polymers in which the structural unit (a1) accounts for 20 to 60 mol %, and preferably from 30 to 50 mol % of all the structural units, the structural unit (a2) accounts for 20 to 60 mol %, and preferably from 30 to 50 mol % of all the structural units, and the structural unit (a3) accounts for 5 to 50 mol %, and preferably from 10 to 40 mol % of all the structural units offer superior etching resistance, resolution, adhesion and resist pattern shape, and are consequently preferred.

Furthermore, for quaternary systems that further comprise the structural unit (a4), polymers in which the structural unit (a1) accounts for 20 to 60 mol %, and preferably from 30 to 50 mol % of all the structural units, the structural unit (a2) accounts for 20 to 60 mol %, and preferably from 30 to 50 mol % of all the structural units, the structural unit (a3) accounts for 5 to 50 mol %, and preferably from 10 to 40 mol % of all the structural units, and the structural unit (a4) accounts for 1 to 30 mol %, and preferably from 5 to 20 mol % of all the structural units are able to maintain the above characteristics, while offering superior resolution for isolated patterns and semi-dense patterns, and are consequently preferred.

More specifically, from the viewpoints of resolution and ensuring a favorable resist pattern shape, a copolymer (i) described below is preferred as the aforementioned resin (A).

Copolymer (i): a copolymer comprising from 20 to 60 mol %, and preferably from 30 to 50 mol % of a structural unit (a1^{m}), from 20 to 60 mol %, and preferably from 30 to 50 moi% of a structural unit (a2^{a}), from 5 to 50 mol %, and preferably from 10 to 40 mol % of a structural unit (a3^{a}), and from 1 to 30 mol %, and preferably from 5 to 20 mol % of a structural unit (a4^{m}). The superscript letter m refers to a methacrylate, and the superscript letter a refers to an acrylate.

There are no particular restrictions on the weight average molecular weight (the polystyrene equivalent value determined by gel filtration chromatography) of the component (A), although values within a range from 5,000 to 30,000 are preferred, and values from 7,000 to 15,000 are even more desirable. If the molecular weight is greater than this range, then the solubility of the component in the resist solvent deteriorates, whereas if the molecular weight is too small, there is a danger of a deterioration in the cross sectional shape of the resist pattern.

The component (A) can be produced easily by a conventional radical polymerization of the monomers corresponding with each of the above structural units (a1) to (a4), using a radical polymerization initiator such as azobisisobutyronitrile (AIBN).

<Component (C)>

The component (C) may be any solvent capable of dissolving the component (A) and the component (B) described above, together with any optional components described below, to generate a uniform solution, and can be one, or two or more solvents selected from amongst known solvents used for conventional chemically amplified resists.

Specific examples of the solvent include ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents can be used singularly, or as a mixed solvent of two or more different solvents.

In particular, mixed solvents of propylene glycol monomethyl ether acetate (PGMEA) and a polar solvent containing a hydroxyl group or a lactone such as propylene glycol monomethyl ether (PGME), ethyl lactate (EL) or γ-butyrolactone offer good solubility of the component (B), and enable a reduction in the particle risk of the positive resist composition, and are consequently preferred. Of these, mixed solvents with EL display good solubility of the component (B) and have a large particle risk reduction effect, and are consequently preferred.

The relative proportions in a mixed solvent of PGMEA and a polar solvent should be determined with due consideration given to factors such as the co-solubility of PGMEA and the polar solvent, but are preferably within a range from 1:9 to 8:2, and even more preferably from 2:8 to 5:5.

More specifically, in those cases where EL is added as the polar solvent, the weight ratio of PGMEA:EL is preferably within a range from 2:8 to 5:5, and even more preferably from 3:7 to 4:6.

If the quantity of PGMEA is greater than the above proportion, then the cross sectional shape of the produced resist pattern tends to adopt a T-top shape. Furthermore, the solubility of the component (B) in the component (C) decreases, and the particle risk tends to increase. In contrast, if the quantity of the polar solvent is greater than the above proportion, then the cross sectional shape of the produced resist pattern tends to adopt a tapered shape, white bands become visible, and film thinning tends to increase. Furthermore, the DOF focus margin also tends to be smaller.

Furthermore, mixed solvents containing at least one of PGMEA and EL, together with γ-butyrolactone, are also preferred as the organic solvent. In such cases, the weight ratio of the former and latter components in the mixed solvent is preferably within a range from 70:30 to 95:5.

<Component ([)>

In a resist composition of the present invention, in order to improve the resist patter shape and the long term stability (post exposure stability of the latent image formed by the pattern wise exposure of the resist layer), a known amine (D), preferably a compound comprising a secondary lower aliphatic amine or a tertiary lower aliphatic amine, can also be added as a separate, optional component.

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine and triethanolamine, and alkanolamines such as triethanolamine are particularly preferred.

These may be used singularly, or in combinations of two or more different compounds.

This component (D) is typically added in a quantity within a range from 0.01 to 2.0% by weight relative to the weight of the component (A).

Miscible additives can also be added to the resist composition according to need, including additive resins for improving the properties of the resist film, surfactants for improving the ease of application, dissolution inhibitors, plasticizers, stabilizers, colorants and halation prevention agents.

A resist composition can be produced by dissolving the aforementioned component (A) and the aforementioned component (B), together with any other optional components, in the component (C). There are no particular restrictions on the quantity of the component (C), although typically a sufficient quantity of the component (C) is added to produce a combined solid fraction concentration of 5 to 50% by weight, and preferably from 7 to 20% by weight, and the quantity is preferably adjusted in accordance with the resist application film thickness.

A resist composition of the present invention is particularly applicable to ArF excimer lasers, although it is also effective for other types of radiation, including radiation of longer wavelength such as KrF excimer lasers, and radiation of shorter wavelength such as F₂ excimer lasers, EUV (extreme ultraviolet radiation), VUV (vacuum ultraviolet radiation), electron beams, X-rays and soft X-rays.

The cross sectional shape of a resist pattern produced using a resist composition obtained using the above type of configuration is a superior shape in which tapers and T-tops have been improved. Furthermore, the occurrence of white bands on the line side wall sections also improves. In addition, the DOF focus margin during exposure is also large.

Furthermore, a resist composition of the present invention displays minimal particle risk during prolonged storage.

<<Method of Forming a Resist Pattern>>

A method of forming a resist pattern according to the present invention can be conducted in the manner described below.

Namely, a resist composition of the present invention is first applied to the surface of a substrate such as a silicon wafer using a spinner or the like, and a prebake is conducted under temperature conditions of 80 to 150° C. for 40 to 120 seconds, and preferably for 60 to 90 seconds, thereby forming a resist film. Following selective exposure of the resist film with an ArF excimer laser through a desired mask pattern using, for example, an ArF exposure apparatus, PEB (post exposure baking) is conducted under temperature conditions of 80 to 150° C. for 40 to 120 seconds, and preferably for 60 to 90 seconds. Subsequently, developing is conducted using an alkali developing liquid such as an aqueous solution of tetramethylammonium hydroxide with a concentration of 0.05 to 10% by weight, and preferably from 0.05 to 3% by weight. In this manner, a resist pattern that is faithful to the mask pattern can be obtained.

An organic or inorganic anti-reflective film may also be provided between the substrate and the applied layer of the resist composition.

### EXAMPLES

As follows is a more detailed description of the present invention using a series of examples.

### Example 1

The components (A) to (D) described below were mixed together and dissolved to prepare a positive resist composition.
Component (A): 100 parts by weight of a polymer (weight average molecular weight=10,000) produced by copolymerization of the following monomers (a1) to (a4):

(a1) 2-ethyl-2-adamantyl methacrylate (35 mol %),

(a2) norbornanelactone acrylate (a monomer which generates the structural unit of the formula 10 wherein R is a hydrogen atom) (40 mol %),

(a3) 3-hydroxy-1-adamantyl acrylate (15 mol %),

(a4) tetracyclododecanyl methacrylate (a monomer which generates the structural unit of the formula 17 wherein R is a methyl group).
Component (B): 3.7 parts by weight of a compound of the formula (II) wherein Y is a nonafluorobutanesulfonate ion.
Component (C): 1300 parts by weight of a mixed solvent of EL/PGMEA (7/3).
Component (D): 0.3 parts by weight of triethanolamine.

### Comparative Example 1

With the exception of replacing the component (B) of the example 1 with 3.5 parts by weight of triphenylsulfonium nonafluorobutanesulfonate, a positive resist composition was prepared using the same operations as the example 1.

### Comparative Example 2

With the exception of replacing the component (B) of the example 1 with 4.0 parts by weight of tri(4-tert-butylphenyl)sulfonium nonafluorobutanesulfonate, a positive resist composition was prepared using the same operations as the example 1.

### Experimental Example 1

[Resist Pattern Shape]

The positive resist compositions obtained in the example 1 and the comparative examples 1 and 2 were each applied to a silicon wafer using a spinner, and were then prebaked and dried on a hotplate at 95° C. for 90 seconds, forming a resist layer with a film thickness of 0.33 μm. Subsequently, this layer was selectively irradiated with an ArF excimer laser (193 nm) through a mask pattern, using an ArF exposure apparatus NSR S-302 (manufactured by Nikon Corporation; NA (numerical aperture)=0.60, ⅔ annular illumination). The irradiated resist was subjected to PEB treatment at 95° C. for 90 seconds, subsequently subjected to puddle development for 60 seconds at 23° C. in a 2.38% by weight aqueous solution of tetramethylammonium hydroxide, and was then washed for 20 seconds with water, and dried.

As a result, a line and space resist pattern with a line width of 80 nm (80 nm/240 nm pitch) was obtained for each composition.

The pattern obtained using the positive resist composition of the example 1 (the example pattern) was compared with the patterns obtained using the positive resist compositions of the comparative examples 1 and 2 (the comparative example patterns 1 and 2).

The results revealed that the cross sectional shape of the comparative example pattern 1 was a tapered shape in which the top section of each line was narrower. Furthermore, marked white bands were visible on the line side walls. If the depth of focus range moved outside the range from −200 nm to +200 nm, then film thinning was particularly significant, meaning the focus margin was narrow.

Furthermore, the cross sectional shape of the comparative example pattern 2 was a T-top shape in which the top section of each line was larger.

In contrast, the resist pattern obtained in the example displayed a rectangular cross sectional shape when compared with the resist patterns of the comparative examples, and there was no loss in the resolution or other lithography characteristics. Furthermore, provided the depth of focus range was maintained within a range from −200 nm to +400 nm, then almost no film thinning was observed, indicating an improvement in the focus margin on the positive side when compared with the comparative example 1.

### Experimental Example 2

[Particle Risk]

The positive resist compositions obtained in the example 1 and the comparative examples 1 and 2 were each stored at room temperature. The number of particles within each resist composition was evaluated using a liquid particle counter (brand name: KS-41, manufactured by Rion Co., Ltd.). The measurement limit is in excess of about 20,000 particles/cm³. Furthermore, the impurities within the resist compositions immediately following production were restricted to no more than 10 particles/cm³.

The results revealed that the positive resist compositions of the example 1 and the comparative example 1 displayed no increase in particle numbers on storage for 1 month at room temperature, and were stable in their respective initial states.

In contrast, the positive resist composition of the comparative example 2 displayed a marked increase in particle numbers, and after 2 weeks storage at room temperature, the composition had reached a state in which the particle numbers had increased beyond the limit of detection (cell NG).

### INDUSTRIAL APPLICABILITY

By using a resist composition comprising a specific compound (I) as an acid generator, a resist composition of the present invention is able to form a resist pattern of good shape, and is consequently extremely useful industrially.

1. A resist composition comprising a resin component (A) that undergoes a change in alkali solubility under action of acid, an acid generator component (B) that generates acid on exposure, and an organic solvent (C), wherein
said component (B) is a compound represented by a general formula (I) shown below: 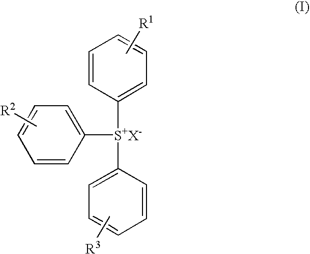
[wherein, R¹ to R³ each represent, independently, a methyl group or an ethyl group; and X⁻ represents an anion].

2. A resist composition according to claim 1, wherein said component (B) is a compound in which said anion X⁻ is a substituted or unsubstituted aliphatic alkylsulfonate ion or arylsulfonate ion.

3. A resist composition according to claim 2, wherein said component (B) is a compound in which said aliphatic alkylsulfonate ion is a fluoroalkylsulfonate ion in which either a portion of, or all hydrogen atoms of an aliphatic alkyl group have been fluorinated or said arylsulfonate ion is a fluoroarylsulfonate ion in which either a portion of, or all hydrogen atoms of an aryl group have been fluorinated.

4. A resist composition according to claim 3, wherein said component (B) is a compound represented by a general formula (II) shown below: 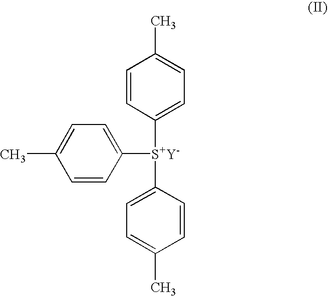
[wherein, Y⁻ represents a trifluoromethanesulfonate ion, a nonafluorobutanesulfonate ion, or a perfluorooctylsulfonate ion].

5. A resist composition according to claim 1, wherein said component (A) comprises a resin containing a structural unit derived from a (meth)acrylate ester.

6. A resist composition according to claim 1, wherein said component (A) comprises a resin containing a structural unit (a1) derived from a (meth)acrylate ester containing an acid dissociable, dissolution inhibiting group.

7. A resist composition according to claim 6, wherein said component (A) comprises a resin that further contains a structural unit (a2) derived from a (meth)acrylate ester containing a lactone unit.

8. A resist composition according to claim 6, wherein said component (A) comprises a resin that further contains a structural unit (a3) derived from a (meth)acrylate ester containing a hydroxyl group.

9. A resist composition according to claim 6, wherein said structural unit (a1) is a structural unit derived from a 2-(1-adamantyl)-2-alkyl(meth)acrylate.

10. A resist composition according to claim 7, wherein said structural unit (a2) is a structural unit derived from a norbornanelactone group containing (meth)acrylate.

11. A resist composition according to claim 8, wherein said structural unit (a3) is a structural unit derived from 3-hydroxy-1-adamantyl(meth)acrylate.

12. A resist composition according to claim 1, wherein said component (C) is a mixed solvent of propylene glycol monomethyl ether acetate and a polar solvent.

13. A resist composition according to claim 12, wherein said polar solvent is ethyl lactate.

14. A resist composition according to claim 1, further comprising a secondary or tertiary lower aliphatic amine component (D).

15. A method of forming a resist pattern comprising the steps of applying a resist composition according to claim 1 to a substrate, conducting a prebake, performing selective exposure, conducting subsequent PEB (post exposure baking), and then performing alkali developing to form a resist pattern.
